(19) United States
(12) Patent Application Publication
(10) Pub. No.: US 2024/0328499 A1
(43) Pub. Date: Oct. 3, 2024

(54) ELECTRIC MOTOR-EQUIPPED AXLE DRIVE DEVICE FOR WORK VEHICLE

(71) Applicant: KANZAKI KOKYUKOKI MFG. CO., LTD., Amagasaki-shi (JP)

(72) Inventors: Shunichi OKAMOTO, Amagasaki-shi (JP); Kentaku JO, Amagasaki-shi (JP)

(21) Appl. No.: 18/619,301

(22) Filed: Mar. 28, 2024

(30) Foreign Application Priority Data
Mar. 31, 2023 (JP) 2023-059312

(51) Int. Cl. F16H 57/021; A01D 34/64; B60K 7/00; B60K 17/04; B60L 15/00; F16H 57/02

(52) U.S. Cl. CPC F16H 57/021; B60K 7/0007; B60K 17/043; B60L 15/007; A01D 34/64; B60K 2007/0061; F16H 2057/02034; F16H 2057/02052; F16H 2057/02056

(57) ABSTRACT

[Problem] In order to mount a pair of electric motor-equipped axle drive devices, each with an integrated inverter, on a work vehicle, it is necessary to have a compact configuration to avoid interference with other vehicle parts. [Solution] The electric motor-equipped axle drive device includes: an axle case that accommodates an input shaft that receives power from the electric motor, a single axle that is substantially parallel to the input shaft, and a gear mechanism that operatively connects the input shaft and the single axle, and the axle case having a section that supports the input shaft and a section that supports the single axle; a motor case of the electric motor that is provided on one side of the input shaft support section; and an inverter that controls the electric motor so as to be capable of supplying electric power, and which includes an inverter case that accommodates a circuit board of the inverter. The inverter case has a base end section that is attached to an end surface or an outer peripheral surface of the motor case, and a terminal section on the opposite side to the base end section. The terminal section is arranged in a space facing one side of the axle support section and is a space on the opposite side to the side on which the axle protrudes.

### CROSS REFERENCE TO RELATED APPLICATIONS

The present invention claims priority under 35 U.S.C. § 119 to Japanese Application, 2023-059312, filed on Mar. 31, 2023, the entire contents of which being incorporated herein by reference.

### TECHNICAL FIELD

The present invention relates to an electric motor-equipped axle drive device used in a work vehicle.

### BACKGROUND ART

It is conventionally known that work vehicles such as riding mower vehicles (riding lawn mowers) provided with a mower device are capable of traveling by driving the wheels with an electric motor. Patent Document 1 describes a riding mower vehicle in which the left and right wheels can be driven independently of each other, with the left wheels being driven by a left electric motor and the right wheels being driven by a right electric motor.

### PRIOR ART DOCUMENT

### Patent Document

Patent Document 1: US-A2016020714

### SUMMARY OF INVENTION

### Technical Problem

In a work vehicle that drives the left and right wheels using two electric motors as described above, electric motor-equipped axle drive devices that include an axle to which wheels can be attached is mounted on a vehicle frame so as to be side-by-side along a width direction of the vehicle. In such an axle drive device, an input shaft that inputs power from the electric motor, a gear mechanism, and an axle are accommodated in an axle case, and the electric motor is fixed to the axle case. A space is prepared in the work vehicle to which the electric motor-equipped axle drive devices are mounted. In order to drive the electric motor, the work vehicle has a battery, a control device and an inverter that are each mounted to appropriate positions of the vehicle frame. Further, a plurality of harnesses are used to connect the battery and the control device, the control device and the inverter, and the inverter and the electric motor. In a system that drives each of the left and right wheels using individual electric motors, the number of harnesses that connect the inverter to the electric motor further increases.

Furthermore, in order to reduce the number of harnesses used, it is conceivable to integrate the inverter with the electric motor-equipped axle drive device. The inverter converts a direct current supplied from a battery into a multi-phase alternating current to supply electrical power to the electric motor, and an inverter case takes up a certain amount of volume because the inverter uses many electronic components and large circuit boards. On the other hand, there is no room to expand the mounting space around the axle drive device mounting space on the work vehicle side because of the presence of components relating to the work machine and the like, and there is a possibility that the inverter integrated with the axle drive device may interfere with the other components. In addition, because the treads of the left and right wheels are determined by the specifications of the work vehicle, when the electric motor-equipped axle drive devices are arranged side-by-side in a vehicle width direction, interference between the inverter cases must also be taken into consideration.

An object of the present invention is to provide a compact, inverter-integrated type electric motor-equipped axle drive device that is capable of being easily mounted on a work vehicle with limited mounting space for an axle drive device, without causing interference with other components.

### Solution to Problem

In an electric motor-equipped axle drive device for a work vehicle according to the present invention, an electric motor-equipped axle drive device is provided as a pair in a work vehicle that travels by independently driving each of a left wheel and a right wheel, and includes: an axle case that accommodates an input shaft that receives power from the electric motor, a single axle that is substantially parallel to the input shaft, and a gear mechanism that operatively connects the input shaft and the single axle, the axle case having a section that supports the input shaft and a section that supports the single axle; a motor case of the electric motor that is provided on one side of the input shaft support section; and an inverter that controls the electric motor so as to be capable of supplying electric power, and which includes an inverter case that accommodates a circuit board of the inverter; wherein, the inverter case has a base end section that is attached to an end surface or an outer peripheral surface of the motor case, and a terminal section on an opposite side to the base end section, and the terminal section is arranged in a space facing one side of the axle support section, and is a space on an opposite side to a side on which the axle protrudes.

According to the electric motor-equipped axle drive device of the present invention, it is possible to ensure the area of the circuit board in the inverter case that is required to maintain the performance of the inverter, while also making it easier to avoid interference with other components on the work vehicle side when mounted on the work vehicle.

Further, according to the electric motor-equipped axle drive device according to a first embodiment of the present invention, a thickness of the base end section of the inverter case is made relatively thin compared to a thickness of the terminal section, and in a state where the base end section of the inverter case is attached to the end surface of the motor case, the terminal section has an increasing thickness toward a direction approaching the axle support section of the motor case.

According to the configuration described above, in the inverter case, by increasing the thickness of the terminal section by making the thickness of the base end section that is attached to the motor case as thin as possible, while also effectively utilizing the dead space that exists around the axle support section, the required volume of the inverter case is ensured, and several circuit boards can be stacked and accommodated in the enlarged volume section.

When the thickness of the base end section that is attached to an end surface of the motor case is made thinner, the tread width of the left and right wheels can be maintained at the dimensions prescribed by the vehicle specifications, irrespective of the presence of two inverter cases between the left and right axle cases.

Alternatively, instead of the above, according to the electric motor-equipped axle drive device for a work vehicle according to a second embodiment of the present invention, a thickness of the base end section of the inverter case is relatively thin compared to a thickness of the terminal section, and in a state where the base end section of the inverter case is attached to an outer peripheral surface of the motor case, an end portion of the terminal section is inclined with respect to an up-down direction so as to be further toward a lower side than an end portion of the base end section.

According to the configuration described above, in the inverter case, by increasing the thickness of the terminal section by making the thickness of the base end section that is attached to the motor case as thin as possible, while also effectively utilizing the dead space that exists around the axle support section, the required volume of the inverter case is ensured, and several circuit boards can be stacked and accommodated in the enlarged volume section.

When the inverter case is attached on an outer peripheral surface of the motor case, because the inverter is not present between the left and right axle cases when the electric motor-equipped axle drive devices are arranged side-by-side in the vehicle, the tread width of the left and right wheels can be maintained at the dimensions prescribed by the vehicle specifications.

### BRIEF DESCRIPTION OF DRAWINGS

FIG. 1 is a side view showing a cross-section of a portion of a vehicle mounted with an electric motor-equipped axle drive device for a work vehicle according to an embodiment of the present invention.

FIG. 2 is a partially omitted plan view of a rear portion of the vehicle in FIG. 1.

FIG. 3 is a perspective view showing the electric motor-equipped axle drive device for a work vehicle shown in FIG. 1 taken out.

FIG. 4 is a schematic diagram showing a configuration for power transmission of the electric motor-equipped axle drive device for a work vehicle in FIG. 3.

FIG. 5 is a plan view of the electric motor-equipped axle drive device for a work vehicle in FIG. 3.

FIG. 6 is a side view of the electric motor-equipped axle drive device for a work vehicle in FIG. 3 viewed from a direction corresponding to the inside of the vehicle.

FIG. 7 is a rear view of the electric motor-equipped axle drive device for a work vehicle in FIG. 3.

FIG. 8 is a plan view showing the motor inverter device taken out from FIG. 3 and partially shown in cross-section.

FIG. 9 is a side view showing a cross-section of a portion of a vehicle mounted with an electric motor-equipped axle drive device for a work vehicle according to another example of an embodiment of the present invention.

FIG. 10 is a partially omitted plan view of a rear portion of the vehicle in FIG. 9.

FIG. 11 is a perspective view showing the electric motor-equipped axle drive device for a work vehicle shown in FIG. 9 taken out.

FIG. 12 is a plan view of the electric motor-equipped axle drive device for a work vehicle in FIG. 11.

FIG. 13 is a side view showing a cross-section of a portion of the electric motor-equipped axle drive device for a work vehicle in FIG. 11 viewed from a direction corresponding to the inside of the vehicle.

FIG. 14 is a rear view of the electric motor-equipped axle drive device for a work vehicle in FIG. 11.

FIG. 15 is a plan view showing the motor inverter device taken out from FIG. 11 and partially shown in cross-section.

### DESCRIPTION OF EMBODIMENTS

The embodiments of the present invention will be described below in detail with reference to the drawings. In the following, although a case will be described in which the electric motor-equipped axle drive device for a work vehicle is mounted on a riding mower vehicle, which is a type of work vehicle, the vehicle on which the electric motor-equipped axle drive device for a work vehicle is mounted is not limited to this, and may be another type of work vehicle having a work machine that performs any one or more types of work among snow removal work, excavation work, civil engineering work, and agricultural work.

Furthermore, the following description is for a case where the vehicle drives two rear wheels using two motors. However, a configuration in which the vehicle drives two front wheels using two motors is also possible.

Alternatively, a configuration in which the front and rear wheels are driven by each of a total of four motors is also possible.

In the following description, the same elements are denoted by the same reference numerals in all of the drawings.

### First Embodiment

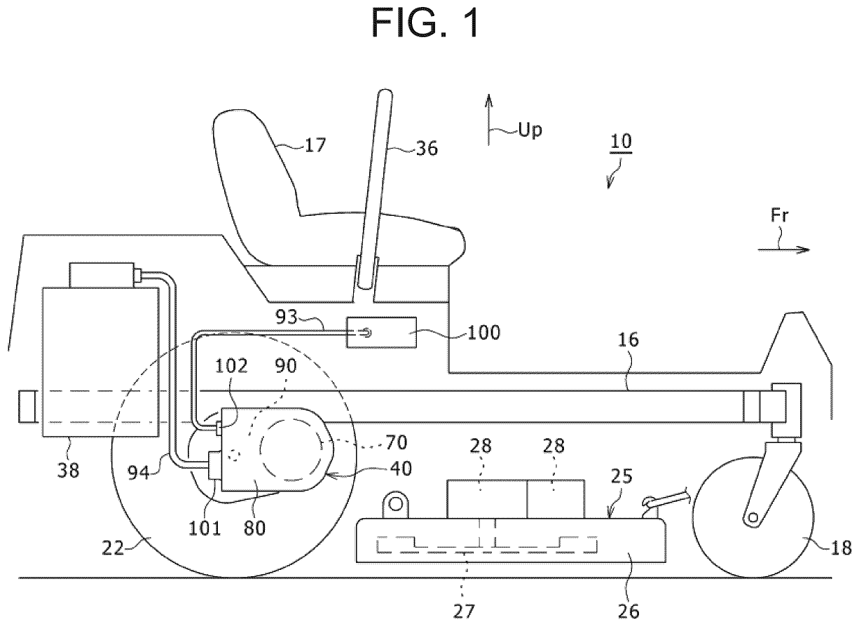

FIG. 1 to FIG. 8 are showing a first embodiment. In the drawings described below, the front side of the vehicle is indicated by Fr, the left side is indicated by Lh, and the upper side is indicated by Up.

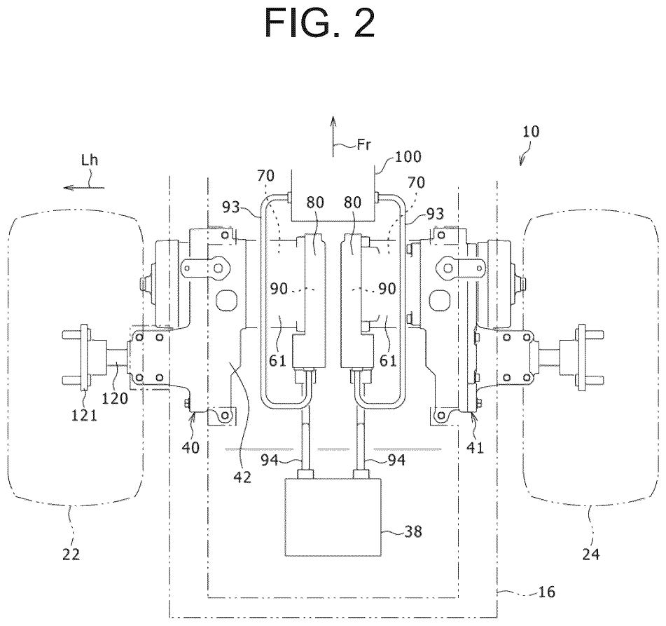

First, an overall configuration of a riding mower vehicle 10 will be described, which serves as an example of mounting electric motor-equipped axle drive devices 40 and 41 for a work vehicle of the present embodiment. Then, the electric motor-equipped axle drive devices 40 and 41 that are mounted on the riding mower vehicle 10 will be described in detail. FIG. 1 is a side view showing a cross-section of a portion of the riding mower vehicle 10 mounted with the electric motor-equipped axle drive devices 40 and 41. FIG. 2 is a partially omitted plan view of a rear portion of the riding mower vehicle 10.

The non-engine mounted, ride-on type riding mower vehicle 10 includes a main frame 16 that constitutes the vehicle body, two caster wheels 18 as left and right front wheels, two wheels 22 and 24 as left and right rear wheels, a mower device 25 as a work machine, a right operation lever 36, a left operation lever (not shown), and a power supply unit 38 containing a battery. In FIG. 1, illustration of the right wheel 24 and the right caster wheel has been omitted.

A driver's seat 17 is fixed to the main frame 16 on an upper side of an intermediate portion in a front-rear direction. The left and right caster wheels 18 are supported on the front side of the main frame 16. Each caster wheel 18 allows free steering of at least 360 degrees about an axis in an up-down direction. The left and right wheels 22 and 24 are supported on the rear side of the main frame 16. The left and right wheels 22 and 24 are main drive wheels and are driven independently of each other by a left and right pair of traveling electric motors 70 described below.

The number of caster wheels 18 may be a number other than two. For example, it is possible to provide only one, or three or more caster wheels 18 on the riding mower vehicle 10. The caster wheels and the drive wheels may be reversed in the front and rear of the configuration of the present example.

The mower device 25 is supported on the main frame 16 on the lower side of an intermediate portion in the front-rear direction. The mower device 25 includes a mower deck 26, three vertical shafts that are rotatably supported on an upper surface of the mower deck 26, and elongated, plate-shaped mower blades 27 that are attached to the lower end of each vertical shaft. As a result of rotating the mower blades 27, it is possible to slice through and cut grass and the like. Each of the mower blades 27 perform a cutting operation as a result of a plurality of electric motors 28 that are installed on the upper surface of the mower deck 26 synchronously driving each of the vertical shafts. Note that a configuration is also possible in which the cutting is accomplished with a single electric motor by interconnecting the three vertical shafts using a belt/pulley mechanism.

The grass can be cut as a result of the rotation of the mower blades 27, and the cut grass is discharged from inside the mower deck 26 to one side of the vehicle in a width direction.

The mower device 25 may be a reel-drum type mower device in which, as a cutting blade for mowing, for example, a spiral blade is arranged on a cylinder having a rotating shaft that is parallel to the ground surface and is driven by an electric motor.

The two operation levers 36 on the left and right are provided on both the left and right sides of the driver's seat 17 and are provided so as to be capable of swinging in the front-rear direction about a horizontal axis oriented in the left-right direction. When the lower section of each operation lever 36 is in an upright, neutral state, the traveling electric motors 70 stop rotating, and when the driver performs a swinging operation to a desired position toward the front or rear, the traveling electric motor 70 on the corresponding side can be rotated in the rotation direction and the rotation speed corresponding to the operation direction and the operation amount. As a result, while traveling, the riding mower vehicle 10 has the left and right wheels 22 and 24 driven by the pair of electric motors 70, which are different and independent of each other.

The swinging position of the operation levers 36 in the front-rear direction is detected by a lever sensor (not shown). The detection signals of the lever sensor are input as signals representing the rotation instruction of the traveling electric motors 70 to a control device 100 that is mounted on the vehicle, and the control device 100 drives the electric motors 70 in a rotation direction and at a rotation speed corresponding to the instruction. The power of each electric motor 70 is transmitted to the left and right wheels 22 and 24 via a gear mechanism and the like of the axle drive devices 40 and 41 described below. As a result, the vehicle travels in a straight line toward the front side or the rear side according to the operation of the operation levers 36, and when the left and right operation amounts are changed with the left and right operation levers 36, a rotation speed difference is generated in the left and right wheels 22 and 24, which allows the advancing direction of the vehicle to be changed. In addition, by tilting one of the two operation levers 36 toward the front side and tilting the other of the operation levers toward the rear side, the left and right wheels 22 and 24 rotate in opposite directions to each other, and it is possible to cause the vehicle to turn on the spot.

Further, the riding mower vehicle 10 is provided with a brake pedal (not shown) on an upper side of a front section of the main frame 16 and near the feet of the driver that is riding in the driver's seat and can be operated by a stepping operation performed by the driver's feet.

The above is the overall configuration of the riding mower vehicle 10. The left and right electric motor-equipped axle drive devices 40 and 41 that are mounted and used in the riding mower vehicle 10 will be described next. The left electric motor-equipped axle drive device 40 is connected to the left wheel 22, and the right electric motor-equipped axle drive device 41 is connected to the right wheel 24. The structure of the right electric motor-equipped axle drive device 41 is the same as the structure of the left electric motor-equipped axle drive device 40, except for being symmetric about the center of the vehicle in the width direction. Therefore, the following description will focus on the left electric motor-equipped axle drive device 40.

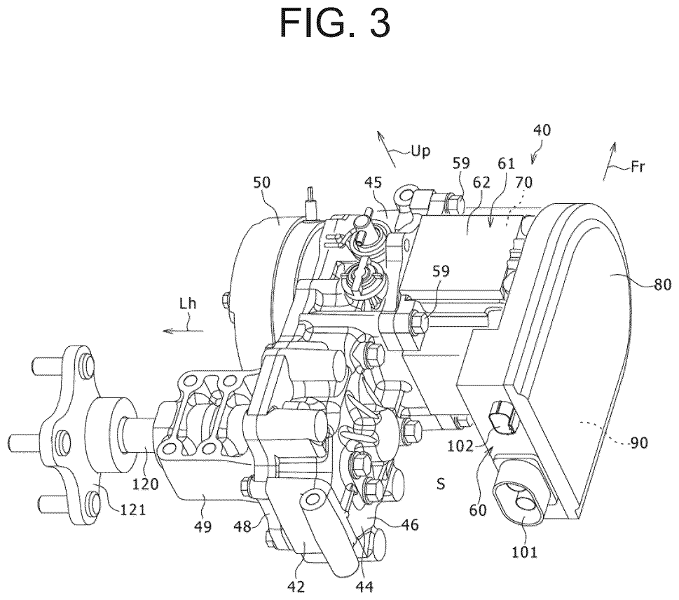

FIG. 3 is a perspective view of the left electric motor-equipped axle drive device 40 before being mounted on the vehicle. The electric motor-equipped axle drive device 40 includes an axle case 42 and a motor inverter device 60. The motor inverter device 60 includes a motor case 61, an inverter case 80, a traveling electric motor 70 that is accommodated in the motor case 61, and an inverter 90 that is accommodated in the inverter case 80. The axle case 42, the motor case 61, and the inverter case 80 are combined into a single body and fixed.

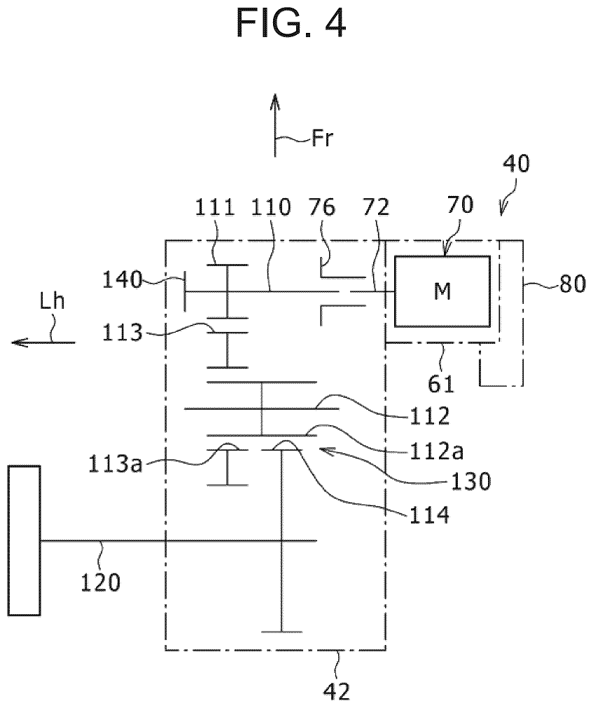

FIG. 4 is a schematic diagram showing a configuration for power transmission of the electric motor-equipped axle drive device 40. The inside of the axle case 42 accommodates an input shaft 110, a single axle 120 that is substantially parallel to the input shaft, and a gear mechanism 130. The axle case 42 includes a section that supports the input shaft 110 on one end side, and a section that supports the single axle 120 on the other end side. The input shaft 110 is connected to a motor shaft 72 of the electric motor 70, and synchronously rotates with the motor shaft 72. The gear mechanism 130 is a mechanism that transmits power between the input shaft 110 and the single axle 120 and transmits a motor power from the input shaft 110 to the single axle 120 at a reduced speed. As a result, the power of the electric motor 70 is transmitted to the single axle 120 via the input shaft 110 and the gear mechanism 130.

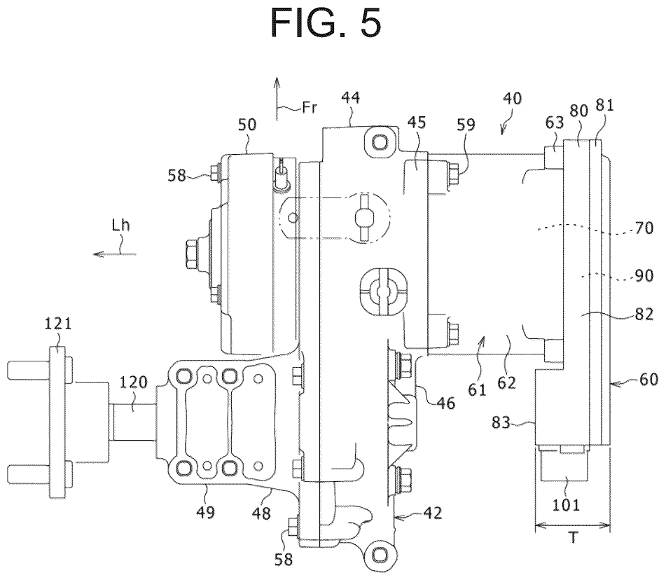

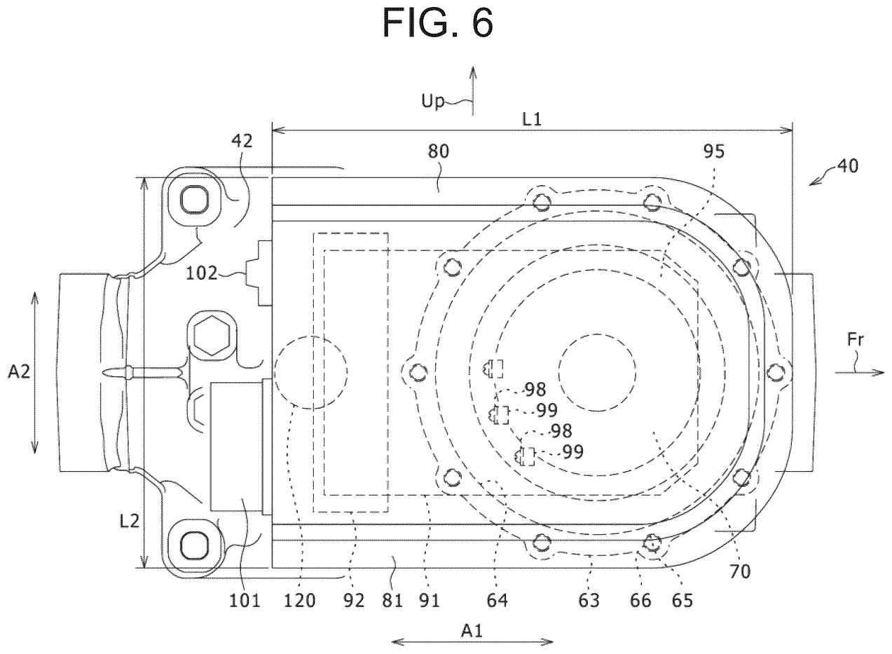

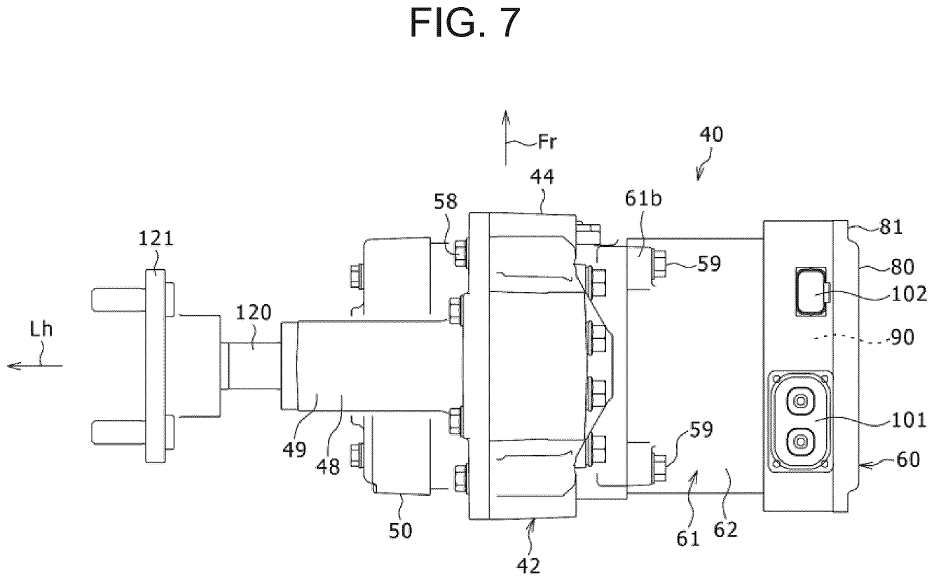

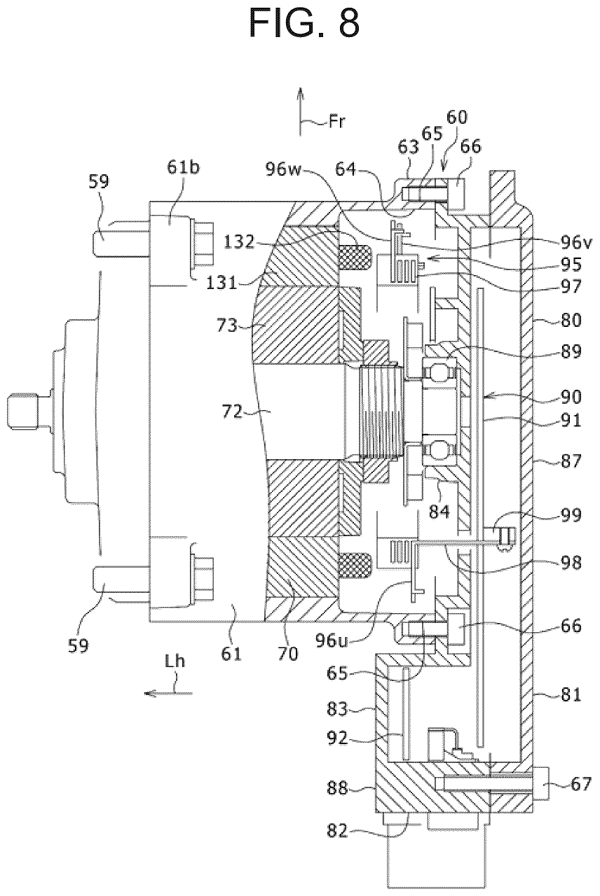

FIG. 5 is a plan view of the electric motor-equipped axle drive device 40. FIG. 6 is a side view of the axle drive device 40 viewed from a direction corresponding to the inside of the vehicle. FIG. 7 is a rear view of the axle drive device 40. FIG. 8 is a plan view showing the motor inverter device 60 taken out from FIG. 3 and partially shown in cross-section.

The axle case 42 is integrated, for example, as a result of a first case member 44 that forms the inner side of the vehicle width direction (the right side of the page in FIG. 5), being one side in the axial direction, a second case member 48 that forms the outer side of the vehicle width direction (the left side of the page in FIG. 5), being the other side in the axial direction being joined by a plurality of bolts 58. Here, the axial direction of the axle drive device 40 is a direction parallel to the input shaft 110 and the single axle 120 and coincides with the vehicle width direction.

The axle case 42 mentioned above includes an input shaft support section 45 on the front side, which is one side in the front-rear direction of the vehicle, and an axle support section 46 on the rear side, which is the other side in the front-rear direction. The input shaft 110 is provided so as to inwardly protrude from the inner side in the vehicle width direction, which is one side of the input shaft support section 45 in the left-right direction of the vehicle. The single axle is provided so as to outwardly protrude from the outer side in the vehicle width direction, which is one side of the axle support section 46 in the left-right direction of the vehicle.

The first case member 44 is a gear case having an inner opening for inserting the motor shaft 72 (FIG. 4) into the input shaft support section 45 described below, which is a front section on the inner side in the vehicle width direction, as well as an outer opening from the front side to the rear side on the outer side in the vehicle width direction. The second case member 48 is open on the inner side in the vehicle width direction, and a cylindrical portion 49 extends in the axial direction from a rear location on an outside surface in the vehicle width direction. The single axle 120 passes through the cylindrical portion 49. The outer end surface of the first case member 44 in the vehicle width direction and the inner end surface of the second case member 48 in the vehicle width direction are joined such that the respective outer peripheral edge portions are abutting each other. As a result, the axle case 42 is formed and a lubricating oil can be stored therein. The gear mechanism 130 (FIG. 4) is accommodated in a gear chamber. Note that an electromagnetic brake case 50, which will be described later, is attached to the outside of the second case member 48 in the vehicle width direction.

On the other hand, the first case and the motor case 61 are joined by a plurality of bolts 59 in a state where one end surface of the substantially cylindrical motor case 61 is in close contact with the end surface around the inside opening of the first case member 44. As a result, the motor case 61 is fixed to one side on the left or right of the input shaft support section 45 of the axle case 42. Consequently, the inside opening of the first case member 44 is closed by the motor case 61. The motor case 61 may be integrally formed on the one side on the left or right of the input shaft support section 45 of the axle case 42.

As shown in FIG. 4, the motor shaft 72 and the input shaft 110 are coaxially arranged with a first brake rotor 76 interposed therebetween. A female spline is formed on the inner periphery of a cylindrical boss portion of the first brake rotor 76, and a portion of the first brake rotor 76 is immersed in lubricating oil.

A male spline is formed on the outer peripheral surface of the abutting sections of the input shaft 110 and the motor shaft 72. The male spline of the first brake rotor 76 is fitted with the abutting sections so as to prevent relative rotation. As a result, the first brake rotor 76 is joined so as to be capable of sliding in the axial direction, but not relatively rotating, with respect to the input shaft 110 and the motor shaft 72.

The first brake rotor 76 constitutes a braking device for travel braking, which is a mechanical brake. Inside the axle case 42, a brake shoe and a brake pad (not shown) face each other on both sides of the first brake rotor 76 in the axial direction. The brake pad is mechanically connected to a brake pedal (not shown) provided on the floor of the driver's seat 17 via a link mechanism. When the driver steps on the brake pedal, the first brake rotor 76 is sandwiched by the brake shoe and the brake pad. As a result, the transmission systems leading to the wheels 22 and 24 undergo simultaneous braking, or the rotation stops. At this time, a change in the power with which the driver steps on the brake pedal enables the pressing force on the first brake rotor 76 to be changed, and the vehicle speed can be adjusted while traveling. In the riding mower vehicle 10, when the driver operates the brake pedal, it is also possible to generate a regenerative braking force by operating the electric motor 70 as a generator, and to cause strong braking of the vehicle using both the regenerative braking force and the mechanical brake.

The outer end portion of the input shaft 110 on the opposite side to the motor shaft 72 outwardly extends from the second case member 48 while maintaining an oil-tight state, and a second brake rotor 140 (FIG. 4) is fixed to the end portion. The second brake rotor 140 is covered with the electromagnetic brake case 50 described above. Inside the electromagnetic brake case 50, a brake pad, an armature, an electromagnetic coil, and a return spring (not shown) are arranged so as to face the side of the second brake rotor 140. A second brake device for parking is configured as an electromagnetic brake and is integrated with the axle case 42 in the manner described above.

The operation levers 36 mentioned above are configured to be operable from a neutral position to a parking position while maintaining the neutral state of the electric motors. When both operation levers 36 are operated to the parking position, each parking brake switch (not shown) is turned on. Upon receiving such a signal, the control device 100 operates both the left and right second brake devices simultaneously and causes the single axle 120 to brake via the second brake rotor 140.

As shown in FIG. 4, the gear mechanism 130 includes a first helical gear 111 provided on the input shaft 110, an intermediate shaft 112 provided with a second helical gear 113 on the outer peripheral surface that is arranged between the input shaft 110 and the single axle 120, and an output gear 114 provided on the single axle 120. The input shaft 110, the intermediate shaft 112, and the single axle 120 are arranged perpendicularly to the joining surfaces of the first case member 44 and the second case member 48 and are supported by bearings so as to span both cases.

The intermediate shaft 112 is provided with a small diameter pinion 112a that is wide in the axial direction. The output gear 114 meshes with the teeth of the small diameter pinion 112a on the right side of the page. Inner teeth 113a formed on the inner peripheral surface of the second helical gear 113 mesh with a teeth portion on the left side of the page and are engaged with each other so as to not relatively rotate.

The number of teeth on the output gear 114 is greater than the number of teeth on the small diameter pinion 112a, and the number of teeth on the second helical gear 113 is greater than the number of teeth on the first helical gear 111. As a result, the rotation of the input shaft 110 is reduced in two stages by the gear mechanism 130 and transmitted to the single axle 120. The outer end portion of the single axle 120 in the vehicle width direction, which extends from the axle case 42, has the wheel 22 fixed thereto via a hub flange 121.

The arrangement configuration of the inverter case 80 that accommodates the inverter 90, and the motor case 61 inside which the electric motor 70 is accommodated according to the first embodiment of the present invention will be described. As described above, the outer end of the motor case 61 in the vehicle width direction, which is an end on one side in the axial direction, is fixed to one side on the left or right of the input shaft support section 45 of the axle case 42. The motor case 61 includes a cylindrical main body portion 62 inside which the electric motor 70 is accommodated, and an annular flange portion 63 (FIG. 6 and FIG. 8) provided on the outer peripheral surface of the inner end of the main body portion 62 in the vehicle width direction, which is the other end.

The inner side of the flange portion 63 is formed having an opening 64 (FIG. 6 and FIG. 8) for installing motor components. Screw holes 65 are formed in the flange portion 63 at a plurality of positions in the circumferential direction. Further, as a result of a plurality of bolts (fasteners) 66 that pass through the outer end portion of the inverter case 80 in the vehicle width direction being joined to the screw holes 65 in the motor case 61, the inverter case 80 is fixed to the end surface on the inner end side of the motor case 61 in the vehicle width direction, which is the other end side.

The electric motor 70 is, for example, a permanent magnet three-phase motor. As shown in FIG. 8, the electric motor 70 includes a motor rotor 73 that is fixed to an outer peripheral surface of the motor shaft 72, a stator core 131 that faces the outer peripheral surface of the motor rotor 73, and a three-phase stator coil 132 that is arranged by being wound around a slot of the stator core 131. The motor rotor 73 includes, for example, permanent magnets that are arranged in a plurality of positions in the circumferential direction of the rotor core. The stator core 131 is fixed to the inner side of the motor case 61. The motor shaft 72 is rotatably supported by the inner side of the motor case 61. As a result of electric power that has been converted to a three-phase alternating current being supplied to the stator coil 132 from the battery of the power supply unit 38 via the inverter 90 described below, the motor shaft 72 rotates due to an interaction between a rotating magnetic field generated in the stator core 131 and a magnetic field generated by the motor rotor 73.

Inside the inverter case 80, the inverter 90 is arranged that converts the direct current supplied from the battery into a three-phase alternating current and supplies the electric power to the electric motor 70. The inverter 90 includes a first circuit board 91 and a second circuit board 92, which has a smaller area than the first circuit board 91, that are arranged parallel to each other inside the inverter case 80. In FIG. 8, illustration of the detailed structure of each circuit board 91 and 92 is omitted. A portion of the wiring between the first circuit board 91 and the second circuit board 92 is connected to each other so that current can be supplied to each other. As a result, the inverter 90 has, for example, an inverter circuit including three arms each having two switching elements that are electrically connected in series, and an inverter control device that controls the inverter circuit.

In FIG. 3 to FIG. 8, the motor case 61 that accommodates the electric motor 70 for the left wheel, which drives the left wheel 22, and the inverter case 80 that accommodates the inverter 90 for the left wheel, which drives the electric motor 70, are shown. On the other hand, as shown in FIG. 2, on the right wheel 24 side, the motor case 61 that accommodates the electric motor 70 for the right wheel, which drives the right wheel 24, and the inverter case 80 that accommodates the inverter 90 for the right wheel, which drives the electric motor 70, are provided.

The operations of each inverter 90 are controlled by the control device 100. The control device 100 is arranged on the upper side of the main frame 16 and on the lower side of the driver's seat 17. The control device 100 and the inverter 90 are connected by a signal cable 93. The control device 100 controls the switching of a switching element of the inverter 90 via the signal cable 93. A direct current is supplied to the inverter 90 from the battery of the power supply unit 38 via a power cable 94. As a result of the control device 100 controlling the switching of the switching element of the inverter 90 via the inverter control device, it is possible for the inverter 90 to convert a direct current to a three-phase alternating current, and supply electric power to the electric motors 70. Consequently, the electric motor 70 for the left wheel is controlled by the control device 100 via the inverter 90 for the left wheel. The electric motor 70 for the right wheel is controlled by the control device 100 via the inverter 90 for the right wheel. As a result, the left and right electric motors 70 are independently controlled by the control device 100 based on signals from the lever sensor mentioned above that represent the rotation direction and rotation speed. Therefore, the left and right electric motors 70 independently drive the left and right wheels 22 and 24 in terms of the rotation direction and rotation speed.

The inverter case 80 has a flat shape in which the maximum thickness T (FIG. 5) is smaller than the maximum dimension L1 (FIG. 6) in a first direction (direction of arrow A1 in FIG. 6) that is orthogonal to the thickness direction. That is, in the inverter case 80, each of the maximum dimensions L1 and L2 in the first direction and a second direction (direction of arrow A2 in FIG. 6), which are orthogonal to the thickness direction and orthogonal to each other, are set to be larger than the maximum thickness T. Here, the “thickness” of the inverter case 80 refers to the dimension in a direction that is orthogonal to the board surface direction of the first and second circuit boards 91 and 92 mentioned above. Furthermore, in the inverter case 80, the maximum dimension L1 in the first direction is larger than the maximum dimension L2 in the second direction. In addition, the maximum dimension L2 is set to substantially the same dimension as the maximum width of the axle case in the up-down direction.

As shown in FIG. 8, the inverter case 80 includes a first plate portion 81 that is positioned on the inner end side in the vehicle width direction, a peripheral wall portion 82 that extends from the outer peripheral edge of the first plate portion 81 to the outer side in the vehicle width direction, and a second plate portion 83 that closes an opening in an outer end of the peripheral wall portion 82 in the vehicle width direction. The peripheral wall portion 82 is substantially letter L-shaped and substantially box-shaped in plan view, and includes a shallow section that accommodates only the first circuit board 91, and a deep section that accommodates both the first circuit board 91 and the second circuit board 92. As shown in FIG. 6, when viewed from the inner side in the vehicle width direction, the first plate portion 81 has an external shape in which the two corner sections at one end in the longitudinal direction (the right end of the page in FIG. 6), which is a first direction of the rectangle shape, have been made curved portions that follow the outer peripheral shape of the motor case 61.

As shown in FIG. 8, the inverter case 80, for example, is configured by a screw connection of a shell-shaped first case 87 and second case 88 using bolts 67. The first plate portion 81 is provided in the first case 87, and the second plate portion 83 is provided in the second case 88. A sealed space formed by the first case 87 and the second case 88 has the first circuit board 91, the second circuit board 92, and wiring back and forth so as to connect the circuit boards to each other. The illustration of the bolts 67 is omitted from FIG. 3, and FIG. 5 to FIG. 7.

A lid portion for closing an opening 64 of the motor case 61 is formed in the second plate portion 83, which forms the rear surface of the second case 88 of the inverter case 80. The lid portion has a plurality of bolt 66 insertion holes that are formed in an arc shaped for fixing to the inner end of the motor case 61. A cylindrical portion 84 is formed protruding on the inner side of the bolt 66 insertion holes, and a bearing 89 that rotatably supports one end portion of the motor shaft 72 is fixed thereto.

The inverter case 80 extends on one side in the longitudinal direction away from the motor case 61, which is a first direction, and the terminal section is arranged in a dead space S (FIG. 3), which is a space facing one side of the axle support section 46 of the axle case 42 in the left-right direction of the vehicle, and is on the opposite side to the protruding side of the single axle 120. In the present example, the first direction of the inverter case 80 is along the front-rear direction of the vehicle, and a second direction is along the up-down direction.

As a result of integrating the inverter case 80 with the electric motor-equipped axle drive device, it is no longer necessary for the harnesses such as the power wires and signal wires that connect the inverter 90 and the electric motor 70 to be prepared by the manufacturer of the work vehicle, which can reduce the manufacturing cost of the electric work vehicle and contribute to the spread of electric work vehicles.

As a result of configuring the inverter case 80 as a flat inverter case 80 that extends on one side in the longitudinal direction away from the motor case 61, and having a first direction dimension, which is orthogonal to the thickness direction, that is larger than the thickness, it is possible to ensure the required area and accommodation space for the circuit boards that constitute the inverter 90, while also preventing interference between the inverter case 80 and the other components on the vehicle side. Here, the interfering “other components” are, for example, in addition to the mower device or the link that suspends the mower device from the vehicle body, the inverter cases 80 that face each other in the electric motor-equipped axle drive device that has been mounted on a mounting space on the vehicle side.

Further, as shown in FIG. 6, when the electric motor 70 is viewed from the axial direction, one end section of the inverter case 80 in the longitudinal direction extends toward the outside in the radial direction from an outer peripheral surface of the motor case 61 (FIG. 5) toward the axle support section 46 of the axle case 42. In addition, a section on one side of the inverter case 80 in the longitudinal direction has a thickness of the inverter case 80 that increases in the direction approaching the axle support section 46. As a result, it is possible to prevent the thickness of the inverter case 80 as a whole from becoming excessively large toward the inside in the vehicle body width direction, while also ensuring the required accommodation space to configure the circuit boards. Also, it is possible to more effectively prevent interference between the inverter case 80 and the other components with a structure in which the inverter case 80 is fixed to an end surface of the motor case 61.

Moreover, as shown in FIG. 8, the circuit boards of the inverter 90 can be placed in a two-level configuration having the first circuit board 91 and the second circuit board 92 on the inner side of a section on one side of the inverter case 80 in the longitudinal direction, and the thickness of the section of the inverter case 80 that is fixed to the motor case 61 can be made smaller. As a result, when the vehicle 10 mounted with the two axle drive devices 40 and 41 on the left and right that drive the wheels 22 and 24 on both the left and right sides is viewed as a whole, the inverter cases 80 do not interfere with each other, and the tread width of the left and right wheels 22 and 24 can be maintained at the dimensions prescribed by the vehicle specifications.

As shown in FIG. 7 and FIG. 8, bolts 59 are inserted and supported by a plurality of mounting bosses 61b on the axle case 42 of the motor case 61. Screw holes (not shown) are formed in the axle case 42 in positions corresponding to the bolts 59 at a peripheral edge portion of an attachment opening for the motor case 61.

As shown in FIG. 8, in the inner space of the motor case 61, a busbar unit 95 including four busbars, which are annular plate-shaped conductive members, is arranged on an end portion on the inverter case 80 side. In the busbar unit 95, three-phase busbars 96u, 96v and 96w of U, V and W phases, and a neutral point busbar 97 are arranged substantially coaxially so as to be aligned in the axial direction. The three-phase busbars 96u, 96v and 96w are each connected to three-phase stator coils 132 of U, V and W phases of the electric motor 70. The neutral point busbar 37 is electrically connected to the three-phase busbars 96u, 96v and 96w. The four busbars 96u, 96v, 96w, and 97 are arranged separated from each other and formed into a unit via an insulating member such as an insulating resin.

As shown in FIG. 6 and FIG. 8, the three-phase busbars 96u, 96v and 96w are each formed having a lead plate 98 that protrudes toward the inverter 90 side from different positions in the circumferential direction along the vehicle width direction, which is parallel to the motor shaft 72. Each of the lead plates 98 passes through the second plate portion 83 of the inverter case 80 and the first circuit board 91 of the inverter 90 and is connected to the connection terminal 99 of the corresponding phase provided on the first circuit board 91 in a wide space on the opposite side to the fixed side of the first circuit board 91 to the inverter 90.

The end surface on one end of the inverter case 80 in the longitudinal direction has a first connector 101 and a second connector 102 attached so as to protrude to the outside. The power cable 94 that is connected to the power supply unit 38 is connected to the first connector 101. As a result, the inverter 90 has electric power supplied from the power supply unit 38 via the first connector 101. The signal cable 93 that is connected to the control device 100 is connected to the second connector 102. As a result, the inverter 90 is capable of transmitting and receiving signals between the control device 100 via the second connector 102. As shown in FIG. 1, when the vehicle is viewed from the vehicle width direction, the power supply unit 38 is arranged on the rear side of the driver's seat 17 of the vehicle. In the front-rear direction of the vehicle, the inverter case 80 is arranged between the power supply unit 38 and the control device 100.

In the present example, the inverter case 80 extends in the front-rear direction of the vehicle in a state where the connectors 101 and 102 are facing the rear side. As a result, it is possible to prevent the power cable 94 that connects the power supply unit 38 and the inverter 90, which are mounted on the rear side of the driver's seat 17 of the vehicle, from becoming excessively long. Furthermore, in a state where the inverter case 80 is supported by the vehicle, the first direction, which is the long direction of the inverter case 80, is along the front-rear direction of the vehicle, which enables the maximum dimension in the second direction, which is the maximum height of both the upper and lower ends, can be made small. As a result, it is possible to more effectively prevent interference between the inverter case 80 and the other components on the vehicle side.

Note that, as another example of a present embodiment, the front-rear direction orientation of the electric motor-equipped axle drive devices 40 and 41 may be reversed from that in FIG. 3. Specifically, in FIG. 3, although the electric motor 70 is arranged in front of the single axle 120, the electric motor 70 may also be arranged behind the single axle 120. In this case, the input shaft support section 45 of the axle case 42 becomes a rear side section, and the axle support section 46 becomes a front side section. Furthermore, the orientation of the inverter case 80 that is fixed to the motor case 61 becomes reversed in the front-rear direction from the case of FIG. 3, and the terminal section on one side in the longitudinal direction away from the motor case 61 of the inverter case 80 is arranged in a dead space, which is a space facing one side of the axle support section on the front side in the left-right direction of the vehicle, and is on the opposite side to the axle protrusion side. In this case, the first connector 101 and the second connector 102 provided in the inverter case 80 face the front side of the vehicle. As a result, although the power cable that connects the inverter 90 and the power supply unit 38 becomes long, the signal cable that connects the inverter 90 and the control device 100 can be made short.

### Second Embodiment

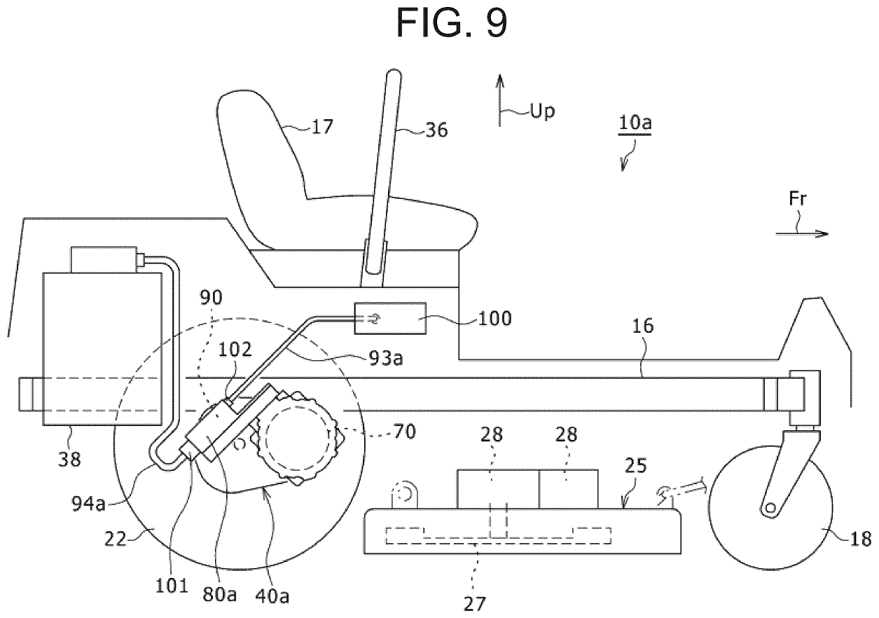

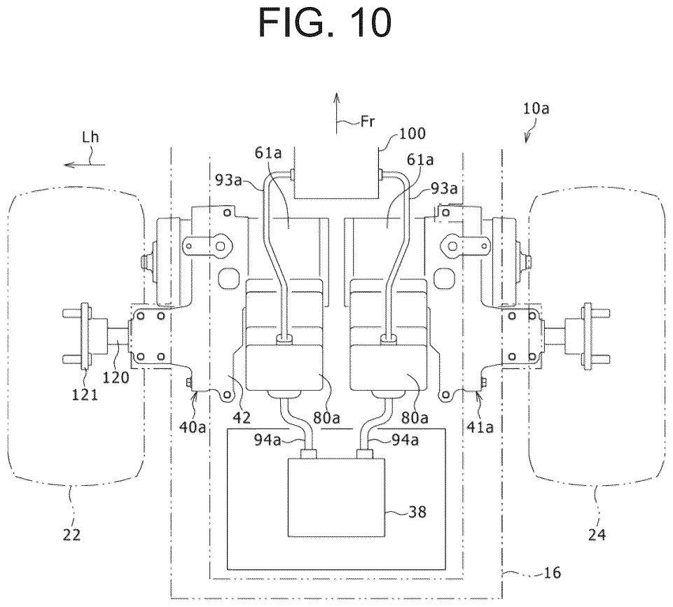

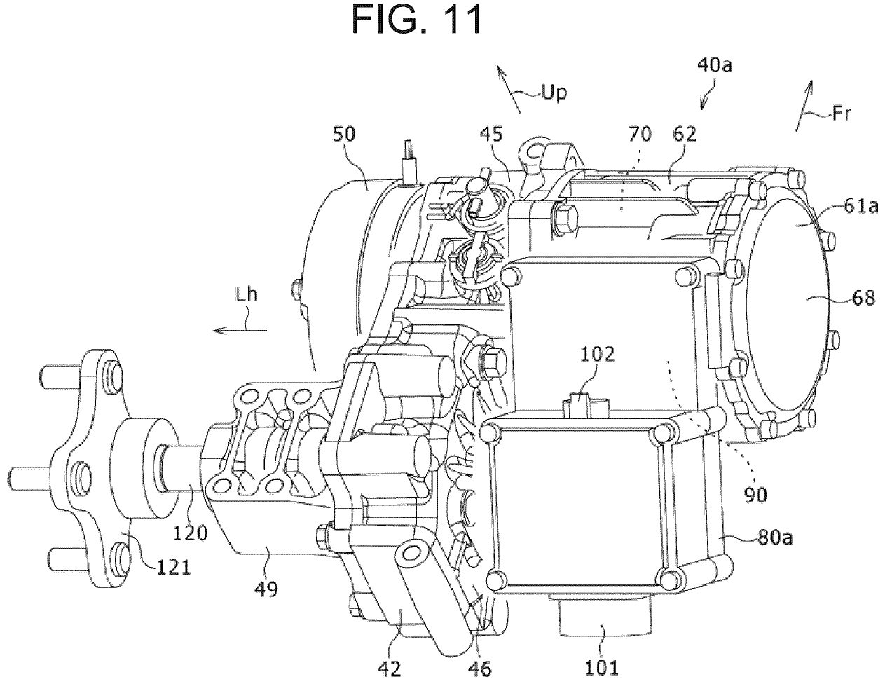

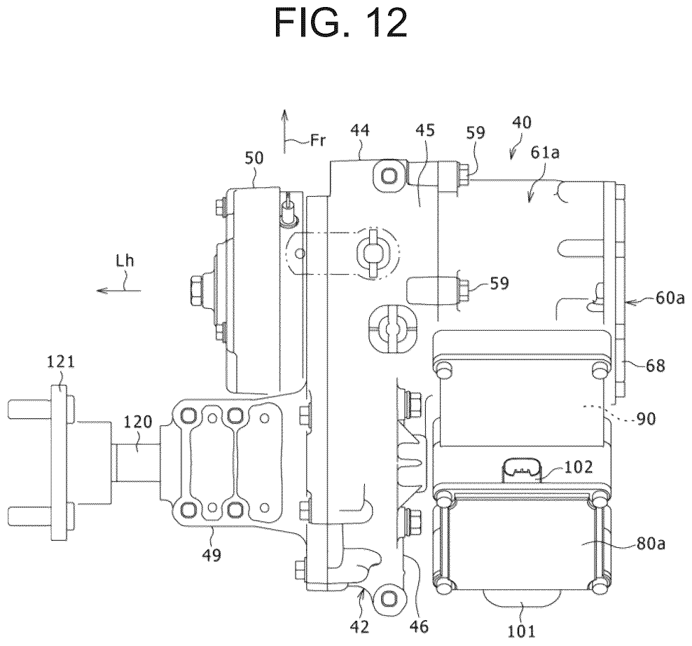

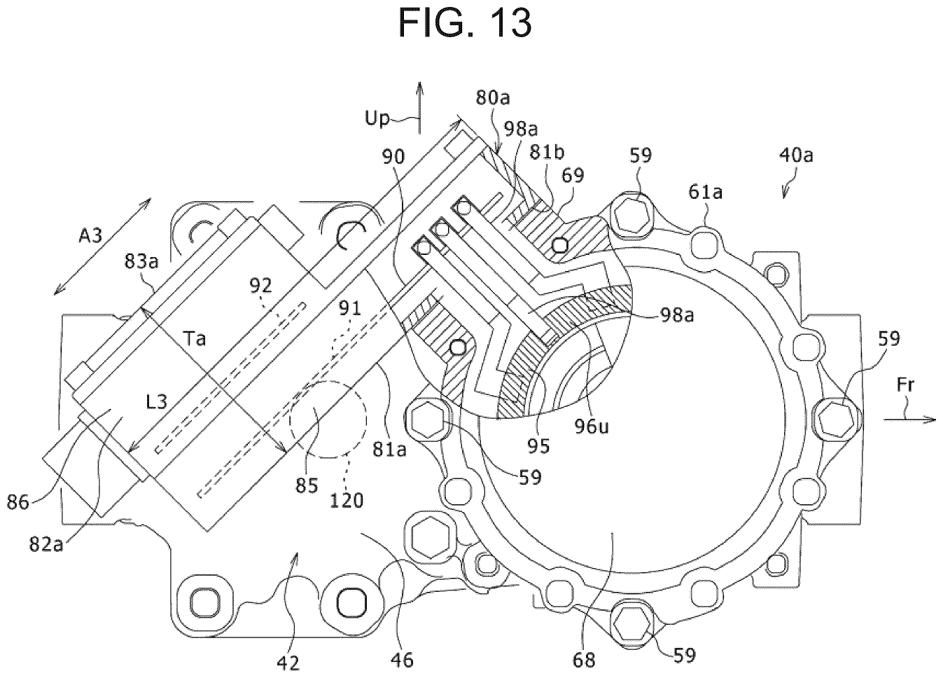

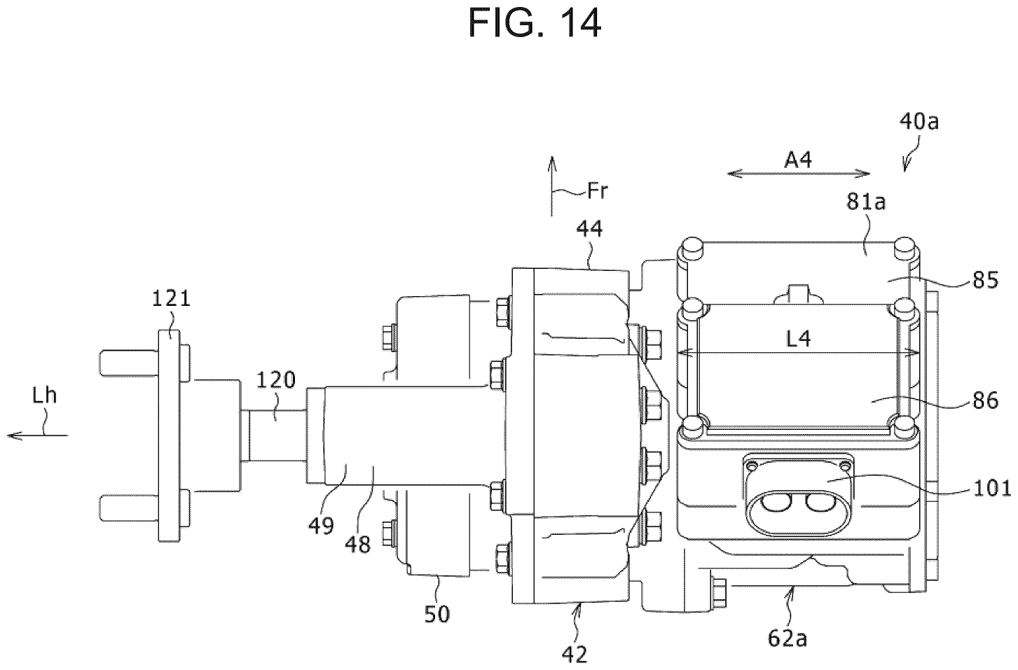

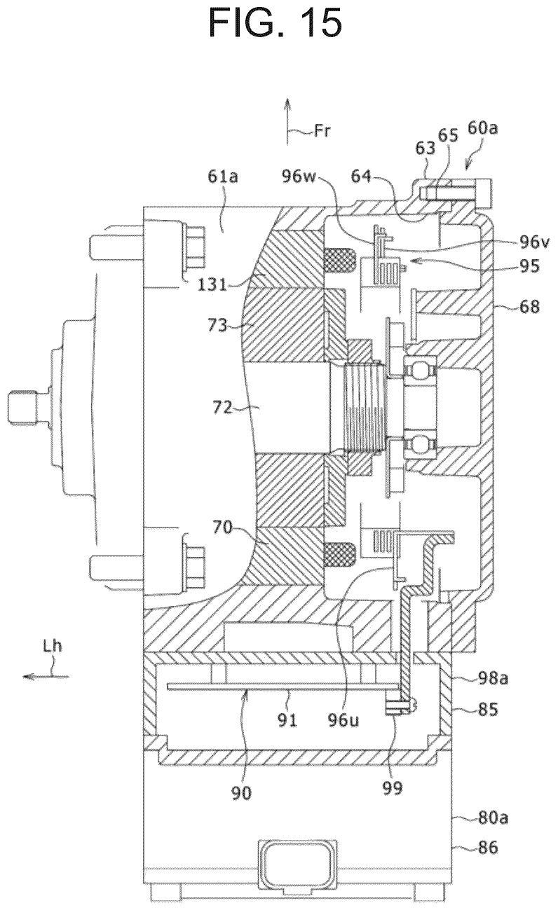

FIG. 9 to FIG. 15 are showing a second embodiment, which is another example of an embodiment. FIG. 9 is a side view showing a cross-section of a portion of a riding mower vehicle 10a mounted with an electric motor-equipped axle drive device 40a of the second embodiment. FIG. 10 is a partially omitted plan view of a rear portion of the vehicle in FIG. 9. FIG. 11 is a perspective view showing the electric motor-equipped axle drive device 40a shown in FIG. 9 taken out. FIG. 12 is a plan view of the axle drive device 40a. FIG. 13 is a side view showing a cross-section of a portion of the electric motor-equipped axle drive device 40a viewed from a direction corresponding to the inside of the vehicle. FIG. 14 is a rear view of the electric motor-equipped axle drive device 40a. FIG. 15 is a plan view showing a motor inverter device 60a taken out from FIG. 11 and partially shown in cross-section.

In the configuration of the present example, unlike the configuration in FIG. 1 to FIG. 8, the electric motor-equipped axle drive device 40a includes an axle case 42 and a motor inverter device 60a. The motor inverter device 60a includes a motor case 61a, an inverter case 80a, a traveling electric motor 70 that is accommodated in the motor case 61a, and an inverter 90 that is accommodated in the inverter case 80a.

In the case of the present example, the inverter case is not fixed to an inner end surface of the main body portion 62 of the motor case 61a on the other end side. Instead, a motor cover 68 is joined to the other end surface using bolts, which closes the opening of the main body portion 62 on the other end side. Further, the inverter case 80a is fixed to the outer peripheral surface of the motor case 61a.

Specifically, an inverter fixing portion 69 (FIG. 13) is provided on the outer peripheral surface of the main body portion 62 and the motor cover 68, and on an outer wall surface facing toward the upper rear side. As shown in FIG. 13, the inverter fixing portion 69 is capable of abutting against a mounting section 81b described below, which is provided on another side of the bottom surface of the inverter case 80a in the longitudinal direction. For example, the inverter fixing portion 69 is configured by a flat surface provided on a leading end surface of a block-shaped protrusion portion that protrudes toward the outside in the radial direction from a section of the outer peripheral surface of the motor case 61 facing the upper rear side. The flat surface is orthogonal to the protruding direction of the protrusion portion.

The inverter case 80a has a flat shape in which the maximum thickness Ta (FIG. 13) is smaller than the maximum dimension L3 (FIG. 13) in a first direction (direction of arrow A3 in FIG. 13) that is orthogonal to the thickness direction. In the inverter case 80a, each of the maximum dimensions L3 and L4 in the first direction and a second direction (direction of arrow A4 in FIG. 14), which are orthogonal to the thickness direction and orthogonal to each other, are set to be larger than the maximum thickness Ta. Similarly, the “thickness” here refers to the dimension in a direction that is orthogonal to a board surface first direction (vertical) and a board surface second direction (horizontal) of the first and second circuit boards 91 and 92 mentioned above. Furthermore, in the inverter case 80a, the maximum dimension L3 in the first direction is larger than the maximum dimension L4 in the second direction. Therefore, the inverter case 80a has a flat shape that is long in the first direction, which is orthogonal to the thickness direction.

The inverter case 80a includes a first plate portion 81a provided on the bottom portion (FIG. 13), a peripheral wall portion 82a that extends from the outer peripheral edge of the first plate portion 81a to the outer side in the vehicle width direction, and a second plate portion 83a that closes an opening in an upper end of the peripheral wall portion 82a, and as shown in FIG. 13, is substantially letter-L shaped and substantially box-shaped in plan view. For example, the inverter case 80a has a shape in which the upper portion on one side of a first section 85, which has a long, rectangular parallelepiped shape with a small thickness, has a second section 86 joined thereto, which has a rectangular parallelepiped shape having a shorter dimension than the longitudinal direction dimension of the first section 85. The first circuit board 91 is accommodated inside the first section 85, and the second circuit board 92 is accommodated inside the second section 86. For example, as a result of bolts passing through the four corners of the second section 86 being joined to screw holes formed in a section of the first section 85 on one side, the second section 86 is fixed to the first section 85. The mounting section 81b that is capable of abutting against the inverter fixing portion 69 is formed by a flat surface on an end portion of the bottom portion of the first section 85 on the other longitudinal direction side. Note that both sections 85 and 86 may be integrally molded to form the inverter case 80a.

The inverter case 80a is fixed to a rear side section of an upper portion of the motor case 61a by a plurality of bolts. At this time, some of the bolts used to join the second section and the first section of the inverter case 80a may be used to fix the inverter case 80a to the motor case 61a by a screw connection.

As shown in FIG. 13 and FIG. 15, in the inner space of the motor case 61a, one end of three lead plates 98a corresponding to the U, V and W phases are connected to different circumferential direction positions of the three-phase busbar 96u, 96v and 96w that constitutes the busbar unit 95 provided on the end portion on the motor cover 68 side. Each of the lead plates 98a are led out to the outside of the motor case 61a in the radial direction. The other end portion of each lead plate 98a that has been led out is introduced into the first section 85 of the inverter case 80a via a radial direction passage inside the inverter fixing portion 69 provided in a circumferential direction portion of the motor cover 68 in a state where an intermediate portion of each lead plate 98a is bent. In this state, the other end portion of each lead plate 98a is connected to the connection terminal 99 (FIG. 15) of the corresponding phase that is provided on the first circuit board 91 inside the first section 85.

In the case of the present example, like the configuration in FIG. 1 to FIG. 8, the inverter case 80a extends on one side in the longitudinal direction away from the motor case 61a, and the terminal section is arranged in a dead space, which is a space facing one side of the axle support section 46 of the axle case 42 in the left-right direction of the vehicle, and is on the opposite side to the axle protruding side. Further, in the configuration of the present example, the other side of the bottom surface of the inverter case 80a in the longitudinal direction is formed having the mounting section 81b, which is fixed to an upper position on the outer peripheral surface of the motor case 61a. At this time, the inverter fixing portion 69 of the inverter case 80a in the motor case 61a is a section of the outer peripheral surface facing the upper rear side.

In addition, the inverter case 80a is inclined with respect to the up-down direction such that the terminal section on one side in the longitudinal direction is further toward a lower side than the mounting section 81b described above. As a result, the terminal section of the inverter case 80a is arranged in the dead space with a downward incline toward the rear side away from the motor case 61. Consequently, it is possible to reduce the amount by which the inverter case 80a protrudes outside the outer peripheral edge of the axle case 42 when viewed in the vehicle width direction, even though the section of the inverter case 80a that extends in the longitudinal direction becomes larger.

Further, because the spacing with respect to the upper end of the axle case 42 becomes wider approaching the terminal section of the inverter case 80a, the thickness Ta on the terminal section side can be made larger than the thickness on the base end section side. Therefore, it is possible to suppress the amount that protrudes outside the upper surface of the axle case 42 when viewed from the up-down direction of the vehicle, while also ensuring the required accommodation space to configure the circuit boards of the inverter.

Therefore, interference between the inverter case 80a and the other components can be more effectively prevented with a structure in which the inverter case 80a is fixed to the outer peripheral surface of the motor case 61a.

Furthermore, the first connector 101 protrudes from an end surface of one end of the inverter case 80a in the longitudinal direction, and the second connector 102 protrudes from an end surface of the other end of the inverter case 80a in the longitudinal direction. The inverter 90 supplies electric power from the power supply unit 38 via the first connector 101 and a power cable 94a that is connected to the first connector 101. On the other hand, the inverter 90 is capable of transmitting and receiving signals between the control device 100 via the second connector 102 via a signal cable 93a that is connected to the second connector 102.

In the present example, in a state where the electric motor-equipped axle drive devices 40a and 41a are mounted on the vehicle, the end surfaces on both sides of the inverter case 80a in the front-rear direction have the first connector 101 and the second connector 102 attached so as to protrude in different directions (in opposite directions). As a result, it is possible to prevent the power cable 94a that connects the power supply unit 38 and the inverter 90, which are mounted on the rear side of the driver's seat 17 of the vehicle, from becoming excessively long. Furthermore, it is possible to prevent the signal cable 93a that connects the control device 100 and the inverter 90, which are mounted on the lower side of the driver's seat 17 of the vehicle, from becoming excessively long.

Although the electric motor-equipped axle drive device 40a for the left wheel has been described above, the electric motor-equipped axle drive device 41a for the right wheel has the same structure as the electric motor-equipped axle drive device 40a for the left wheel, except for being symmetric about the center of the vehicle in the width direction. In the present example, the other configurations and actions are the same as the configurations in FIG. 1 to FIG. 8.

Note that, as another example of an embodiment, the front-rear direction orientation of the electric motor-equipped axle drive devices 40a and 41a may be reversed from that in FIG. 11. Specifically, in FIG. 11, although the electric motor 70 is arranged in front of the single axle 120, the electric motor 70 may also be arranged behind the single axle 120. In this case, the input shaft support section 45 of the axle case 42 becomes a rear side section, and the axle support section 46 becomes a front side section. Furthermore, the inverter case 80a that is fixed to the motor case 61a is reversed in the front-rear direction from that in FIG. 11. In addition, the fixed portion of the inverter case 80a on the motor case 61a becomes a section that is oriented toward the upper front side, and the inverter case 80a is downwardly inclined toward the front side away from the motor case 61a.

### REFERENCE SIGNS LIST

10, 10a Riding mower vehicle
16 Main frame
17 Driver's seat
18 Caster wheel
22, 24 Wheel
25 Mower device
26 Mower deck
27 Mower blade
28 Electric motor
30 Shaft member
36 Operation lever
38 Power supply unit
40, 41, 40a, 41a Electric motor-equipped axle drive device
42 Axle case
44 First case member
45 Input shaft support section
46 Axle support section
48 Second case member
50 Electromagnetic brake case
58, 59 Bolt
60, 60a Motor inverter device
61, 61a Motor case
61b Mounting boss
62 Main body portion
63 Flange
64 Opening
65 Screw hole
66, 67 Bolt
68 Motor cover
69 Inverter fixing portion
70 Electric motor
72 Motor shaft
73 Motor rotor
80, 80a Inverter case
81, 81a First plate portion
81b Mounting section
82, 82a Peripheral wall portion
83, 83a Third plate portion
84 Cylindrical portion
85 First section
86 Second section
87 First case
88 Second case
89 Bearing
90 Inverter
91 First circuit board
92 Second circuit board
93, 93a Signal cable
94, 94a Power cable
95 Busbar unit
96u, 96v, 96w Busbar
97 Neutral point busbar
98, 98a Lead plate
99 Connection terminal
100 Control device
101 First terminal
102 Second terminal
110 Input shaft
112 Intermediate shaft
114 Output gear
120 Axle
130 Gear mechanism
131 Stator core
132 Stator coil

1. An electric motor-equipped axle drive device, being provided as a pair in a work vehicle that travels by independently driving each of a left wheel and a right wheel, comprising:
an axle case that accommodates an input shaft that receives power from the electric motor, a single axle that is substantially parallel to the input shaft, and a gear mechanism that operatively connects the input shaft and the single axle, the axle case having a section that supports the input shaft and a section that supports the single axle;
a motor case of the electric motor that is provided on one side of the input shaft support section; and
an inverter that controls the electric motor so as to be capable of supplying electric power, and which includes an inverter case that accommodates a circuit board of the inverter; wherein
the inverter case has a base end section that is attached to an end surface or an outer peripheral surface of the motor case, and a terminal section on an opposite side to the base end section, and the terminal section is arranged in a space facing one side of the axle support section and is a space on an opposite side to a side on which the axle protrudes.

2. The electric motor-equipped axle drive device for a work vehicle according to claim 1, wherein
a thickness of the base end section of the inverter case is relatively thin compared to a thickness of the terminal section, and
in a state where the base end section of the inverter case is attached to the end surface of the motor case, the terminal section has an increasing thickness toward a direction approaching the axle support section of the motor case.

3. The electric motor-equipped axle drive device for a work vehicle according to claim 1, wherein
a thickness of the base end section of the inverter case is relatively thin compared to a thickness of the terminal section, and
in a state where the base end section of the inverter case is attached to an outer peripheral surface of the motor case, an end portion of the terminal section is inclined with respect to an up-down direction so as to be further toward a lower side than an end portion of the base end section.
